(19) United States
(12) Patent Application Publication
(10) Pub. No.: US 2014/0260971 A1
(43) Pub. Date: Sep. 18, 2014

(54) Ceramic Membrane

(71) Applicant: Dru L. DeLaet, St. Louis, MO (US)

(72) Inventor: Dru L. DeLaet, St. Louis, MO (US)

(21) Appl. No.: 14/218,915

(22) Filed: Mar. 18, 2014

Related U.S. Application Data
(60) Provisional application No. 61/793,802, filed on Mar. 15, 2013.

(51) Int. Cl. C04B 35/591; C01B 3/50

(52) U.S. Cl. CPC C04B 35/591; C01B 3/503
USPC 95/55; 501/154

(57) ABSTRACT

The preparation and use of polysilazane ceramic precursor polymer to make ceramic membranes to purify small molecules, such as hydrogen, for the purpose of isolating the gas and manipulating its potential as an alternative fuel source composition are described. The disclosed materials are composed of an amorphous form of SiₓN_{y}, derived from a SiₓN_{y}H_{z} precursor, with channels interlaced throughout the composition. These channels are formed during the release of H₂ gas from the SiₓN_{y}H_{z} material formed when the SiₓN_{y}H_{z} material is heated.

### RELATED APPLICATIONS

The present application claims benefit from earlier filed U.S. Provisional Application No. 61/793,802, filed Mar. 15, 2013, which is incorporated by reference in its entirety for all purposes.

### BACKGROUND

1. Field of the Invention

This application is directed to preparation and use of polysilazane ceramic precursor polymer to make amorphous nanoporous ceramic membranes to purify small molecules, such as hydrogen, for the purpose of isolating the gas and manipulating its potential as an alternative fuel source.

2. Discussion of the Related Art

It is clear that current methods of preparing H₂ are not fully energy-conserving from the perspective of a life-cycle analysis. The oxidation of metal with acid is certainly not cost effective. The largest commercial method of utilizing methane or small organics with steam is not only energy inefficient, but also produces additional greenhouse gases.

There exists a broad area of applications in which industrial chemical processes produce hydrogen as a byproduct. In these cases, hydrogen partial pressures will be significant and separation should be possible. Current organic membranes have limited use when other highly oxidative gases are present. Both organic and ceramic membranes have trade-offs between selectivity and permeability. A method which would retrieve this hydrogen would be one of a host of options to reduce dependence on fossil fuels, improve greenhouse gas emissions and add to the arsenal of energy possibilities.

Porous ceramic and glass materials have been utilized as filtering devices for decades, with sintered glass filters being the most common. It has, however, only been recently that ceramic materials have been developed which can selectively perform at the molecular and ionic levels. Initiated by the development of ion selective electrode membranes such as NISACON and modified Zeolites have been used to transfer sodium ions.

Polysilazanes were prepared and studied as early as the 1960s and showed great promise in many ceramic applications. Yet most of these materials serve as either binders for ceramic powder—in order to keep shrinkage to a minimum—or as precursors to amorphous ceramic materials with unique physical properties which may replace metals in certain high-temperature applications. Nearly all of the prior materials were prepared from alkylsilanes and ammonia, creating SiCN ceramics. SiCON and SiAlON ceramics have been prepared by others in this field.

The organic membranes used commercially are not always viable candidates (for example, hydrogen gas separation from off gases emanating from chloro-alkali plants and other similar plants). Tremendous amounts of hydrogen gas currently go untapped at these facilities because the organic membranes available today have only limited life in these applications, making hydrogen recovery at these operations an unattractive option to pursue. Even ceramic options using sol-gel are not as selective as necessary. It is clear that selectivity vs. permeability is the trade-off. Fabricating membranes from polysilazane ceramic precursor polymer is a possible resolution to this problem.

### SUMMARY OF THE INVENTION

The present disclosure is directed to a method of purifying a hydrogen gas-containing atmosphere by providing a hydrogen gas-containing gas, providing a filtration medium comprised of a material comprised of Si and N in a 3:4 ratio, contacting the hydrogen gas-containing gas with the filtration medium, and filtering the hydrogen gas-containing gas through the filtration medium to produce essentially pure hydrogen gas.

Further disclosed herein is a composition composed of an amorphous form of SiₓN_{y}, derived from a SiₓN_{y}H_{z} material, with channels interlaced throughout the composition. These channels are formed during the release of H₂ gas from the SiₓN_{y}H_{z} material formed when the SiₓN_{y}H_{z} material is heated to a first temperature, and the x ranges from 2.7 to 3.3, and y ranges from 3.6 to 4.4.

In yet another embodiment of the present disclosure is a method of preparing a composition by providing a SiₓN_{y}H_{z}-containing material, heating the SiₓN_{y}H_{z}-containing material to a first temperature sufficient to remove substantially all of the H present therein, and forming an amorphous nanoporous ceramic material comprised of SiₓN_{y}. For this material, x ranges from 2.7 to 3.3, and y ranges from 3.6 to 4.4.

### DETAILED DESCRIPTION OF THE INVENTION

In more detail, the present invention includes a method of purifying a hydrogen gas-containing atmosphere comprising providing a hydrogen gas-containing gas, providing a filtration medium comprised of a material comprised of Si and N in a 3:4 ratio, contacting the hydrogen gas-containing gas with the filtration medium, and filtering the hydrogen gas-containing gas through the filtration medium to produce essentially pure hydrogen gas.

For the present method the material comprised of Si and N in a 3:4 ratio comprises an amorphous, nanoporous ceramic composition, and is derived from a SiₓN_{y}H_{z} material by heating the SiₓN_{y}H_{z}-containing material to a temperature sufficient to remove substantially all of the H present therein. This treatment temperature is less than the temperature sufficient to sinter the SiₓN_{y}H_{z}-containing material, but is generally greater than 675 C.

It should be noted that herein the material comprised of Si and N in a 3:4 ratio is referred to in that fashion in order to differentiate it from the crystalline form of Si₃N₄, otherwise known as silicon nitride.

Also described in the present application is a composition made of an amorphous form of SiₓN_{y}, derived from a SiₓN_{y}H_{z} material, with channels interlaced throughout the composition. Of interest is that these channels are formed during the release of H₂ gas from the SiₓN_{y}H_{z} material formed when the SiₓN_{y}H_{z} material is heated to a first temperature, and are therefore sized to allow H₂ and smaller particles to pass. The Si and N elements are present in the materials with x ranging from 2.7 to 3.3, and y ranging from 3.6 to 4.4, in some embodiments of this composition x ranges from 2.85 to 3.15, and y ranges from 3.8 to 4.2.

This composition is heated to a first temperature that is less than the temperature sufficient to sinter the SiₓN_{y}H_{z} material, and typically is greater than 675 C.

This composition can be utilized to filter a gas mixture comprising hydrogen gas.

Finally disclosed is a method of preparing a composition beginning with providing a SiₓN_{y}H_{z}-containing material, heating the SiₓN_{y}H_{z}-containing material to a first temperature sufficient to remove substantially all of the H present therein, and forming an amorphous nanoporous ceramic material comprised of SiₓN_{y}, wherein x ranges from 2.7 to 3.3, and y ranges from 3.6 to 4.4.

For this inventive method x ranges from 2.85 to 3.15, and y ranges from 3.8 to 4.2, and the first temperature is less than the temperature sufficient to sinter the SiₓN_{y}H_{z}-containing material, and can be greater than 675 C.

One aspect of the present disclosure is the formation of internal channels within the polysilazane ceramic precursor polymer from the hydrogen gas being evolved and subsequently forming channels. These channels are, according to present theory but not limited thereto, regular and enable the resulting amorphous nanoporous ceramic material to be utilized to separate hydrogen gas through simple compression methods. In some embodiments of the present disclosure, the disclosed membranes can be prepared to purify other small molecules such as methane.

These presently disclosed polysilazane ceramic precursor polymer produce an amorphous, nanoporous Si₃N₄ ceramic. This material is then heated to less than sintering temperatures to eliminate hydrogen with no ammonia or silane decomposition. The thusly prepared amorphous nanoporous ceramic membrane prepared by off-gassing hydrogen can address various concerns. With the treated polysilazane formed into disc-shaped pieces and then heated to temperatures sufficient to drive out the hydrogen, a Si₃N₄, that is, with Si and N present in a 3:4 ratio, amorphous ceramic material with channels formed by the driven off hydrogen is produced.

In order to condense the ammonia and dichlorosilane into the reaction and keep the reactants all in the same liquid phase, a cooling unit which can begin at −20° C., and then be ramped above room temperature, is needed to perform the synthesis correctly. It is also important to monitor the internal temperature of the reaction in case the forming ammonium chloride precipitate insulates the reaction mass. The materials produced can be isolated by a stainless steel pressure filter system which can be used inside an enclosed environmental chamber to filter the ammonium chloride from the reaction mass.

Pyrolysis, or conversion of the polymers, into green bodies which are no longer air/moisture sensitive requires an inert atmosphere and is best accomplished by utilizing a tube furnace. However, the final conversion to the amorphous material can be accomplished in air using a larger bulk oven.

The polysilazane ceramic precursor polymer as prepared in the Example can be further processed by being formed into disc-shaped pieces which can then be heated to temperatures sufficient to drive out the hydrogen, and to form Si₃N₄ amorphous nanoporous ceramic with channels formed by the driven off hydrogen. The channels formed in the material provide a structure which permits hydrogen or smaller particles to pass through the material.

In some other embodiments of the present disclosure, a thin ceramic disc of the material can be fabricated, the membrane will be sealed onto a glass vacuum system. The gas composition of the low pressure side of the device will be tested by GC, and the rate of H₂ isolation will be based on the pressure and flow rate of H₂ through the device. Size and thickness of the material discs will be determined for optimal use and construction in scale-up of syntheses and fabrication.

### EXAMPLE

### 5.2/1 Mol Ratio

Charge 635 g of tetrahydrofuran to a suitable reaction vessel and cool to −20° C. While stirring at 500 rpm, condense 36.92 g of dichlorosilane into the tetrahydrofuran under vacuum and add 12.02 g of tetrachlorosilane by syringe. Then bubble ammonia into the solution at a rate of about 400 cc/minute, initially causing the pressure to increase to about 69 kPa and the temperature to rise to −13° C.

Continue adding ammonia for two hours to allow the reaction to proceed with the precipitation of ammonium chloride. At this point, the amount of ammonia consumed is 35.75 g and the pressure has risen to 0.2 MPa, but the temperature has dropped to −20° C. Allow the reaction mass to warm to room temperature overnight while stirring. The pressure increases to slightly above 0.3 MPa. Transfer the solution to an inert atmosphere box, filter and vacuum-strip the filtrate to dryness.

The reaction results in a 97% isolated yield of ammonium chloride and a 74.3% isolated yield of a soluble polysilazane ceramic precursor polymer which gives a ceramic yield of 90% by TGA (25°-1000° C. at 10 degree/minute).

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A method of purifying a hydrogen gas-containing atmosphere comprising
providing a hydrogen gas-containing gas,
providing a filtration medium comprised of a material comprised of Si and N in a 3:4 ratio,
contacting the hydrogen gas-containing gas with the filtration medium,
filtering the hydrogen gas-containing gas through the filtration medium to produce essentially pure hydrogen gas.

2. The method according to claim 1, wherein the material comprised of Si and N in a 3:4 ratio comprises an amorphous, nanoporous ceramic composition.

3. The method according to claim 2, wherein the material comprised of Si and N in a 3:4 ratio is derived from a SiₓN_{y}H_{z} material by heating the SiₓN_{y}H_{z}-containing material to a temperature sufficient to remove substantially all of the H present therein.

4. The method according to claim 3, wherein the temperature is less than the temperature sufficient to sinter the SiₓN_{y}H_{z}-containing material.

5. The method according to claim 3, wherein the temperature is greater than 675 C.

6. The method according to claim 3, wherein channels sized to allow hydrogen gas to pass are formed in the material comprised of Si and N in a 3:4 ratio after heating.

7. A composition comprising
an amorphous form of SiₓN_{y}, derived from a SiₓN_{y}H_{z} material, with channels interlaced throughout the composition,
wherein the channels are formed during the release of H₂ gas from the SiₓN_{y}H_{z} material formed when the SiₓN_{y}H_{z} material is heated to a first temperature, and x ranges from 2.7 to 3.3, and y ranges from 3.6 to 4.4.

8. The composition according to claim 7, wherein x ranges from 2.85 to 3.15, and y ranges from 3.8 to 4.2.

9. The composition according to claim 7, wherein the first temperature is less than the temperature sufficient to sinter the SiₓN_{y}H_{z} material.

10. The composition according to claim 7, wherein the temperature is greater than 675 C.

11. The composition according to claim 7, wherein the composition is utilized to filter a gas mixture comprising hydrogen gas.

12. A method of preparing a composition comprising
providing a SiₓN_{y}H_{z}-containing material,
heating the SiₓN_{y}H_{z}-containing material to a first temperature sufficient to remove substantially all of the H present therein,
forming an amorphous nanoporous ceramic material comprised of SiₓN_{y},
wherein x ranges from 2.7 to 3.3, and y ranges from 3.6 to 4.4.

13. The method according to claim 12, wherein x ranges from 2.85 to 3.15, and y ranges from 3.8 to 4.2.

14. The method according to claim 12, wherein the first temperature is less than the temperature sufficient to sinter the SiₓN_{y}H_{z}-containing material.

15. The method according to claim 12, wherein the temperature is greater than 675 C.
